(19) United States
(12) Patent Application Publication
(10) Pub. No.: US 2012/0118073 A1
(43) Pub. Date: May 17, 2012

(54) APPARATUS FOR MEASURING VOLUME-OR MASS-FLOW OF A MEDIUM IN A PIPELINE

(75) Inventor: Roger Kerrom, Lorrach (DE)

(73) Assignee: Endress + Hauser Flowtec AG, Reinach (CH)

(21) Appl. No.: 12/309,646

(22) PCT Filed: Jun. 28, 2007
(86) PCT No.: PCT/EP2007/056509

§ 371 Date: Aug. 31, 2011

(30) Foreign Application Priority Data
Jul. 26, 2006 (DE) 10 2006 035 231.9
Jan. 18, 2007 (DE) 10 2007 003 614.2

(51) Int. Cl. G01F 1/58

(52) U.S. Cl. 73/861.08

(57) ABSTRACT

In order to place a medium flowing through a magneto-inductive flow measuring device at a reference potential, a grounding gasket is arranged, in each case, between flared end regions of the measuring tube, or measuring tube flanges secured on the measuring tube, and pipeline flanges connected with the pipeline. The grounding gasket comprises a conductive support material. The support material is provided with an electrically conductive, chemically resistant, plastics coating, at least in regions in contact in the installed state with the medium, the flared end regions, or the measuring tube flanges, as the case may be, and the pipeline flanges.

The invention relates to an apparatus for measuring volume- or mass-flow of a medium in a pipeline. The apparatus includes: A measuring tube, through which medium flows in the direction of the measuring tube axis and which is mounted in the pipeline via two pipeline flanges secured to the pipeline, wherein the measuring tube is flared at both of its end regions or wherein the measuring tube has a measuring tube flange at each of its end regions, wherein, between a flared end region, or a measuring tube flange, and the corresponding pipeline flange, a grounding gasket is provided, via which the medium is placed at a reference potential; a magnet system, which produces a magnetic field passing through the measuring tube essentially transversely to the measuring tube axis; at least one measuring electrode, which is coupled with the medium and arranged in a region of the measuring tube lying essentially perpendicularly to the magnetic field; and a control/evaluation unit, which, on the basis of the measurement voltage induced in the at least one measuring electrode, delivers information concerning volume- or mass-flow of the medium in the measuring tube.

Magneto-inductive flow measuring devices utilize for volumetric flow measurement the principle of electrodynamic induction: Charge carriers of the medium moved perpendicularly to a magnetic field induce a measurement voltage in measuring electrodes likewise arranged essentially perpendicularly to the flow direction of the medium. The measurement voltage induced in the measuring electrodes is proportional to the flow velocity of the medium averaged over the cross section of the measuring tube; the measurement voltage is thus proportional to volume flow. The measurement voltage is usually tapped via a measuring electrode pair arranged in the region of maximum magnetic field strength, thus in the region, in which maximum measurement voltage is to be expected. The measuring electrodes are either galvanically or capacitively coupled with the medium.

Securement of a magneto-inductive flow measuring device in a pipeline is accomplished on both sides usually via two flanges, of which one is secured on the pipeline and the other on the measuring tube of the flow-measuring device. Besides the affixing of the flow measuring device in the pipeline via flanges, it is also known to construct the flow measuring device in the form of a wafer and to clamp the wafer between the two flanges of the pipeline, using a securement mechanism.

In order to increase the sensitivity of a magneto-inductive flow measuring device, it is necessary, that the medium lies at a defined reference potential, e.g. at ground potential. For this, usually a grounding gasket is positioned between each end region of the measuring tube and the corresponding pipeline flange, or between each measuring tube flange and the corresponding pipeline flange, as the case may be. The grounding gaskets are positioned in such a manner that they lie in contact with the medium flowing through the pipeline and the measuring tube. The grounding gaskets are given ground potential, or some other reference potential, via appropriate connections thereof.

Special measures must be accessed, when the medium is an aggressive, corrosive medium. In this connection, it is already known to manufacture the grounding gasket of a chemically inert, synthetic material, or plastic, with incorporated, conductive particles. Used by the assignee for this purpose is a grounding gasket of PTFE containing carbon particles. PTFE is preferred, since it is chemically inert.

A disadvantage of a grounding gasket of PTFE becomes evident in certain cases of application, especially when flow measuring devices of large nominal diameter are secured in a pipeline with correspondingly high bearing pressure. Since PTFE is a relatively soft material, there is, already at relatively small bearing pressures, the danger, that the PTFE will lose its form stability and start to flow. Due to surface alteration of the grounding gasket, it can then occur, that a leakage starts in the region of the connection between flow measuring device and pipeline. Since a grounding gasket of synthetic material is relatively soft, there is, further, also the danger, that leakage can occurs just as a result of mechanical surface damage at the bearing locations between measuring tube and pipeline.

A known solution for the above stated problem provides, instead of a grounding gasket of synthetic material, a grounding gasket of metal. However, if the medium to be measured or monitored is an aggressive, corrosive medium, then the metal of the grounding-gasket must be a chemically inert metal. A metal suitable for this purpose is, for example, tantalum, wherein tantalum has the known disadvantage, that it is relatively expensive. If the grounding gasket of tantalum is applied in the range of large nominal diameters, then the manufacturing costs for the magneto-inductive flow measuring device are driven very significantly higher.

A particular embodiment of a quite universally applicable grounding-gasket is described in EP 1 186 867 A1. The grounding gasket of the invention described below can have both that particular shape as well as also any other shape.

An object of the invention is to provide, in a magneto-inductive flow measuring device, a grounding gasket, which is both cost-favorable and suitable for use in the case of corrosive media.

The object is achieved by the features that: The grounding gasket is manufactured of a conductive support material; and the support material is provided with an electrically conductive, chemically resistant, plastics layer, at least in regions in contact in the installed state with the medium and the flared end regions or flanges of the measuring tube and pipeline. The grounding gasket of the invention is, thus, applicable both in the case of the flange version of a magneto-inductive flow measuring device, as well as also in the case of an embodiment of the magneto-inductive flow measuring device as a wafer.

The advantages of the grounding gasket of the invention lie, on the one hand, in its form stability in the case of high bearing pressures, and, on the other hand, in its high corrosion resistance.

In a preferred embodiment of the grounding gasket of the invention, the support material of the grounding gasket is steel or stainless steel. Especially, the thickness of the support material is then dimensioned, such that the grounding gasket is bending-resistant as a function of the bearing pressure acting on it in the installed state. In this way, a deformation of the grounding gasket, which, on occasion, leads to a leakage at the location of installation of the flow measuring device, is effectively prevented. Furthermore, an advantageous embodiment of the solution of the invention provides, that the conductive plastics coating is a coating of modified PTFE. It has been found to be especially advantageous to incorporate particles of a conductive material into the modified PTFE. Such particles are preferably carbon-particles.

Moreover, it is provided, that the thickness of the plastics coating is a fraction of the thickness of the support material. In such case, it is to be heeded that all surface regions of the support material to be covered are provided continuously with the plastics layer. The layer should, thus, not be so thin, that it is porous. Just any thickness can, however, also not be applied, since, then, again, the problem of form instability under bearing pressure can arise. A protective layer, which is as thin as possible, has, furthermore, the advantage, that the surface coating is then very hard. Consequently, it is, in such case, largely resistant to mechanical damage by scoring or scratching.

The invention will now be explained in greater detail on the basis of the appended drawing, the figures of which show as follows:

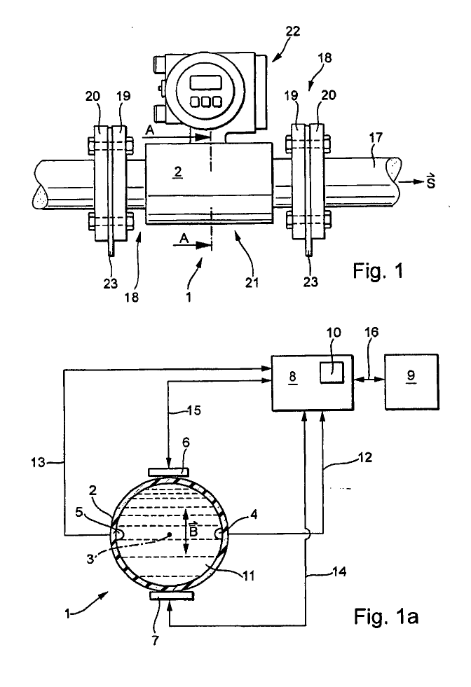

FIG. 1a schematic drawing of a form of embodiment of the magneto-inductive flow measuring device of the invention;

FIG. 1a a partial cross section taken according to the cutting plane A-A of FIG. 1;

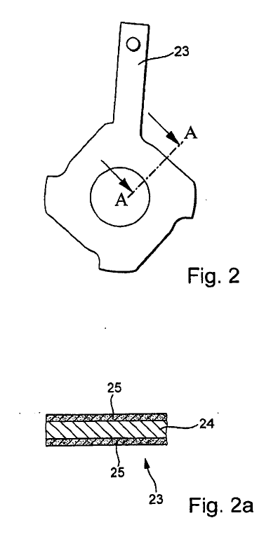

FIG. 2 a plan view of a grounding gasket of the invention; and

FIG. 2a a cross section taken according to the cutting plane A-A of FIG. 2.

FIG. 1 is a plan view of a form of embodiment of the apparatus 1 of the invention. The flow-measuring device 1 installed in the pipeline 17 is composed of a sensor 21 and a transmitter 22.

Arranged in the transmitter 22 are the sensitive electrical components, e.g. the control/evaluation unit 8.

Secured in the two end regions 18 of the measuring tube 2 of the flow measuring device 1 is, in each case, a measuring tube flange 19. The measuring tube flanges 19 are either welded onto the measuring tube 2, or the measuring tube flange 19 is a loose flange, which was slid onto the measuring tube 2 and is secured, via a flared end region 18 of the measuring tube 2, in the installed state of the flow measuring device 1, axially against the measuring tube 2.

The two pipeline flanges 20 are mounted on the two end regions of the pipeline 17, between which the flow measuring device 1 is positioned. Provided between a measuring tube flange 19 and a pipeline flange 20 is, in each case, a grounding gasket 23 of the invention. Besides the grounding function, the grounding gasket 23 in the shown case also functions as a seal. Of course, the sealing function can also be assumed by an additional seal. This alternative, however, is not shown in the FIG. 1.

FIG. 1a is a cross section taken according to the cutting plane A-A of FIG. 1. Medium 11 flows through the measuring tube 2 in the direction of the measuring tube axis 3. Medium 11 is at least slightly electrically conductive. Measuring tube 2 itself is made of a non-conductive material, or, at least, it is lined on its inner surface with a liner of a non-conductive material.

The magnetic field B directed perpendicularly to the stream direction S of the medium 11 is produced by two diametrally arranged, electromagnets 6, 7. Under the influence of the magnetic field B, charge carriers located in the medium 11 migrate, depending on polarity, to the two oppositely poled measuring electrodes 4, 5. The measurement voltage U1 building on the measuring electrodes 4, 5 is proportional to the flow velocity of the medium 11 averaged over the cross section of the measuring tube 2, i.e. it is a measure for the volume flow rate of the medium 11 in the measuring tube 2.

In the two illustrated cases, the measuring electrodes 4, 5 are in direct contact with the medium 11; the coupling can, however, such as already mentioned above, also be done capacitively.

Via connecting lines 12, 13, the measuring electrodes 4, 5 are connected with the control/evaluation unit 8. The connection between the electromagnet 6, 7 and the control/evaluation unit 8 is accomplished via the connecting lines 14, 15. The control/evaluation unit 8 is connected via the connecting line with an input-output unit 9. Associated with the evaluation/control unit 8 is a memory unit 10.

FIG. 2 shows a plan view of a grounding gasket 23 of the invention. FIG. 2a is a cross section taken according to the cutting plane A-A of FIG. 2. Grounding gasket 23 has, in the shown case, the same shape as the grounding gasket of EP 1 186 867 A1. Of course, the grounding gasket 23 can have any other shape. Important is, that the inner diameter of the central bore of the grounding gasket be essentially equal to the inner diameter of the pipeline 17.

Construction of the grounding gasket 23 is quite evident from the cross section shown in FIG. 2a. The grounding gasket 23 is composed of a conductive support material 24. The support material 24 is provided with an electrically conductive, chemically resistant, plastics coating 25 in regions in contact in the installed state with the medium 11, with the flared end regions 18, or with the measuring tube flanges 19, as the case may be, and with the pipeline flanges 20. Preferably, the plastics coating 25 is PTFE having inclusions of carbon. The plastics coating 25 can be applied by means of all established coating methods onto the support material 24 in a thickness optimal for the pertinent application.

### LIST OF REFERENCE CHARACTERS

1. magneto-inductive flow measuring device
2. measuring tube
3. measuring tube axis
4. measuring electrode
5. measuring electrode
6. electromagnet
7. electromagnet
8. control/evaluation unit
9. input/output unit
10. memory unit
11. medium
12. connecting line
13. connecting line
14. connecting line
15. connecting line
16. connecting line
17. pipeline
18. measuring tube end region
19. measuring tube flange
20. pipeline flange
21. sensor
22. transmitter
23. grounding gasket
24. support material
25. plastics coating

1-6. (canceled)

7. An apparatus for measuring volume- or mass-flow of a medium in a pipeline, comprising:
a measuring tube, through which the medium flows in a direction of a measuring tube axis and which is mounted in the pipeline via two pipeline flanges secured on the pipeline, said measuring tube is being flared at both of its end regions, or said measuring tube has, at each of its end regions, a measuring tube flange; a grounding gasket is provided between a flared end region, or a measuring tube flange, and a pipeline flange, via which the medium is placed at a reference potential;
a magnet system, which produces a magnetic field passing through the measuring tube essentially transversely to the measuring tube axis;
at least one measuring electrode coupled with the medium and arranged in a region of the measuring tube lying essentially perpendicular to the magnetic field; and
a control/evaluation unit, which, on the basis of a measurement voltage induced in said at least one measuring electrode, delivers information concerning volume- or mass-flow of the medium in said measuring tube, wherein:
said grounding disk comprises a conductive support material, and
said support material is provided with an electrically conductive, chemically resistant, plastics coating, at least in regions in contact in an installed state with the medium, the flared end regions, or the measuring tube flanges, as the case may be, and the pipeline flanges.

8. The apparatus as claimed in claim 7, wherein:
said grounding gasket comprises steel or stainless steel.

9. The apparatus as claimed in claim 7, wherein:
the thickness of said support material is such that said grounding gasket is essentially torsionally stiff as a function of bearing pressure acting on it in the installed state.

10. The apparatus as claimed in claim 7, wherein:
said conductive plastics coating is a coating of modified PTFE.

11. The apparatus as claimed in claim 10, wherein:
particles of a conductive material are incorporated in the modified PTFE.

12. The apparatus as claimed in claim 7, wherein:
the thickness of said plastics coating is a fraction of the thickness of said support material.
